(19) United States
(12) Patent Application Publication
(10) Pub. No.: US 2010/0187328 A1
(43) Pub. Date: Jul. 29, 2010

(54) PORTABLE ULTRASONIC MIST GENERATING DEVICE

(76) Inventors: Yoshimitsu Konishi, Kyoto (JP); Makiko Konishi, Kyoto (JP)

Correspondence Address: Muncy, Geissler, Olds & Lowe, PLLC, 4000 Legato Road, Suite 310, FAIRFAX, VA, 22033, US

(21) Appl. No.: 12/668,155

(22) PCT Filed: Oct. 12, 2007
(86) PCT No.: PCT/JP2007/069981

§ 371 Date: Jan. 7, 2010

(30) Foreign Application Priority Data
Jul. 24, 2007 (JP) 2007-192086

(51) Int. Cl. B05B 1/08

(52) U.S. Cl. 239/102.1

(57) ABSTRACT

Regarding a portable ultrasonic mist generating device, to make a device compact and prevent the amount of mist from decreasing by making the device compact. A cover 12 is arranged above a liquid surface 10. The cover 12 is a dome-like shaped. Therefore, it is possible to collide the liquid column 10 against the cover 12 and restrict the height of a liquid column 11 by the cover 12. And it is possible to guide drops of the liquid column 11 to direct then around the liquid column 11 at positions away from the liquid column 11. The drops of the liquid column 11 falls to the liquid surface 10.

### TECHNICAL FIELD

The present invention relates to a portable ultrasonic mist generating device.

### BACKGROUND ART

The applicant developed and proposed a new type of portable ultrasonic mist generating device before filing this application, as described in the Japanese Unexamined Patent Application Publication No. 2005-111328 (Patent document 1) and the Japanese Unexamined Patent Application Publication No. 2006-142119 (Patent document 2).

The device includes a liquid containing tank and an ultrasonic vibrator. The tank includes a bottom provided with the vibrator. The vibrator vibrates a liquid of the tank at ultrasonic frequency to squirt a liquid column from a liquid surface and generate a mist from the liquid column. The mist is very fine. Further, the device includes a nozzle connected to the tank and a fan transmitting air to the tank, thereby transmitting the mist by the air and squirting the mist from the nozzle. Therefore, for example, the device can be used for a beauty treatment, in which a person sprays the mist on her or his face so that the mist can be absorbed in the skin.

By the way, in this case, it is preferable to make the device compact for convenience in carrying. Meanwhile, the mist is important as a matter of cause. The amount of mist must be prevented from decreasing when making the device compact.

It is, therefore, an object of the present invention to provide a portable ultrasonic mist generating device to make the device compact and prevent the amount of mist from decreasing when making the device compact.
Patent document 1: Japanese Unexamined Patent Application Publication No. 2005-111328
Patent document 2: Japanese Unexamined Patent Application Publication No. 2006-142119

### DISCLOSURE OF THE INVENTION

A portable ultrasonic mist generating device includes a liquid containing tank and an ultrasonic vibrator. The tank includes a bottom provided with the vibrator. The vibrator vibrates a liquid of the tank at ultrasonic frequency to squirt a liquid column from a liquid surface and generate a mist from the liquid column. The device includes a dome-like shaped cover arranged above the liquid surface. The liquid column collides against the cover. The cover restricts a height of the liquid column, guiding drops of the liquid column to direct them around the liquid column. The drops of the liquid column fall to the liquid surface at positions away from the liquid column. The device includes a nozzle connected to the tank and a fan transmitting air to the tank, thereby transmitting the mist by the air and squirting the mist from the nozzle.

According to a preferable embodiment, the cover is a polygon-shaped in plan view to have a plurality of corners. Therefore, the drops of the liquid column fall from each of the corners.

Further, a flow passage is formed from the fan to the tank through a position above a center portion of the tank in a horizontal direction.

Further, a flow passage is formed from the nozzle to the tank through a position above the center portion of the tank in the horizontal direction.

### BRIEF DESCRIPTION OF THE DRAWINGS

FIG. 1 is a longitudinal-sectional view illustrating an embodiment of the present invention.

FIG. 2 is a longitudinal-sectional view illustrating a fan and a heat sink tube in FIG. 1.

FIG. 3 is a bottom view illustrating a cover in FIG. 1.

### DESCRIPTION OF THE REFERENCE CHARACTERS

2 liquid containing tank
3 ultrasonic vibrator
5,6 liquid
10 liquid surface
11 liquid column
12 cover
13 corner
14 nozzle
15 flow passage
16 fan
17 flow passage

### BEST MODE FOR CARRYING OUT THE INVENTION

Hereinafter, an embodiment of the present invention will be described.

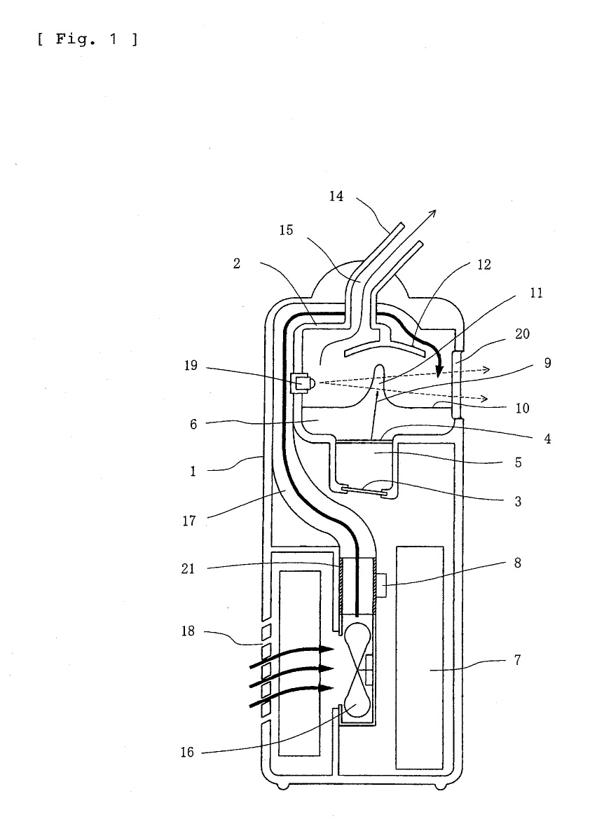

FIG. 1 illustrates a portable ultrasonic mist generating device according to the present invention. The device has a case 1, a liquid containing tank 2, and a ultrasonic vibrator 3. The case 1 has a size capable of being grasped and held with one hand. The tank 2 is housed in an upper portion of the case 1, and the tank 2 includes a bottom provided with the ultrasonic vibrator 3. In this embodiment, a permeable film 4 is provided in the tank 2 so that the tank 2 can be divided into an upper portion and a lower portion, the bottom of the lower portion being provided with the ultrasonic vibrator 3. Further, a liquid 5 is filled in the lower portion of the tank 2 and confined by the permeable film 4, a liquid 6 being introduced into the upper portion of the tank 2. The permeable film 4 is composed of a thin sheet made of synthetic resin.

Further, an electronic device 7 and a power transistor 8 are housed in the lower portion of the case 1 and connected to the ultrasonic vibrator 3. The ultrasonic vibrator 3 is energized by the electronic device 7 and the power transistor 8 to generate an ultrasonic 9. The ultrasonic 9 permeates through the permeable film 4 in a direction vertical to the ultrasonic vibrator 3. Therefore, the liquid 5,6 of the tank 2 is vibrated by the ultrasonic vibrator 3 at ultrasonic frequency, the liquid column 11 squirting from a liquid surface 10 so that a mist can be generated by the liquid column 11. The mist is very fine.

It should be understood that the permeable film 4 is arranged in a horizontal direction, but the ultrasonic vibrator 3 inclines at a certain degree so that the ultrasonic 9 is directed in a direction not vertical but inclined to the film 4. Therefore, when reaching the permeable film 4, the ultrasonic 9 does not reflect from the ultrasonic vibrator 3 so that the ultrasonic vibrator 3 can not be damaged by the reflected ultrasonic 9.

Further, regarding the device, the cover 12 is combined with the tank 2, housed in the upper portion of the case 1 and arranged above the liquid surface 10. The cover 12 is dome-like shaped to have an outer peripheral edge arranged around the liquid column 9. Therefore, when the liquid column 11 squirts from the liquid surface 10, the liquid column 11 collides against the cover 12 so that the cover 12 can restrict the height of the liquid column 11. It should be understood that the liquid column 11 can not squirt beyond and above the cover 12 to have the height restricted at the level of the cover 12. Further, since the cover 12 is dome-like shaped, when the liquid column 11 collides against the cover 12, its drops are guided by the lower surface of the cover 12 to move along the lower surface of the cover 12. The drops are then directed around the liquid column 11 to fall to the liquid surface 10 at positions far away from the liquid column 11.

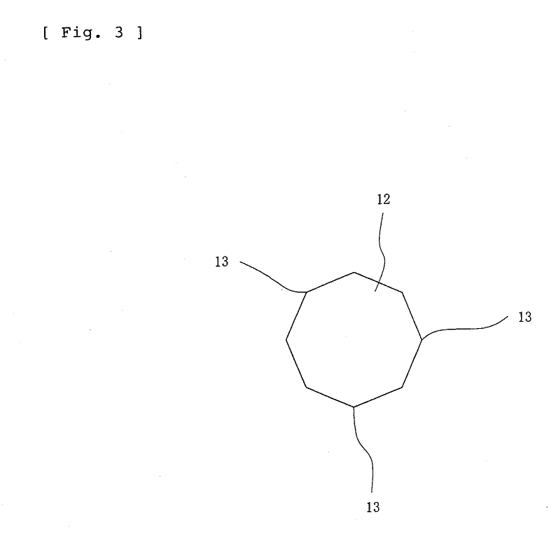

Further, as shown FIG. 3, the cover 12 is a polygon-shaped in plan view to have a plurality of corners 13. For example, the cover 12 is an octagon-shaped to have eight corners 13. Therefore, the drops of the liquid column 11 are directed to each of the corners 13 to fall from each of the corners 13. The cover 12 may be a pentagon-shaped or a hexagonal-shaped.

Further, the device has a nozzle 14 connected to the tank 2. The nozzle 14 is combined with the upper end of the case 1 to project outwardly of the upper end. Further, a flow passage 15 is formed from the nozzle 14 to the tank 2. The flow passage 15 opens to the tank 2 at a position on one side of the cover 12 in a horizontal direction. Meanwhile, the nozzle 14 projects outwardly of the case 1 at a position above the center portion in a horizontal direction or a position above the other side in a direction horizontal to the cover 12. The cover 12 is arranged on the center portion of the tank 2 in a horizontal direction. Therefore, the flow passage 15 is formed from the nozzle 14 to the tank 2 through a position above the center portion of the tank 2 in a horizontal direction.

Further, a fan 16 is housed in the lower portion of the case 1. The fan for supplying air comprises a sirocco fan. Further, a flow passage 17 is formed from the fan 16 to the tank 2, and arranged in a vertical direction at one side position in a horizontal direction to reach to the position above the center portion of the tank 2 and the cover 12 in a horizontal direction. Further, the flow passage 17 opens to the tank 2 around the cover 12. Therefore, the flow passage 17 is formed from the fan 16 to the tank 2 through the position above the center portion of the tank 2 in the horizontal direction.

Further, slits 18 are formed in the side wall of the case 1 and opposed to the fan 16. Therefore, air is sucked from the slit 18 to be transmitted to the tank 2 through the flow passage 17. Further, the mist is transmitted by air to squirt from the nozzle 14 through the flow passage 15. Therefore, for example, the device can be used for a beauty treatment, in which a person sprays the mist on her or his face so that the mist can be absorbed in the skin. The liquid 5,6 is made of water.

Therefore, in case of the device, the height of the liquid column 11 is restricted by the cover 12 so that the height of the tank 2 can be decreased. Accordingly the device has no problem of installation space for the tank 2. As a result, it is possible to make the device compact.

Further, the liquid column 11 collides against the cover 12, as stated above, the drops of the liquid column 11 being directed around the liquid column 11 to fall to the liquid surface 10 at positions away from the liquid column 11. Further, the drops do not fall to the liquid column 11 to decay the liquid column 11. When the mist is generated by the liquid column 11, the drops do not fall to the mist to decay the mist around the liquid column 11.

Further, regarding the device, as stated above, the drops of the liquid column 11 are directed to each of the corners 13 to fall from each of the corners 13. Therefore, the drops do not fall from the positions between each of the corners 13 to decay the mist. The mist passes through the positions between each of the corners 13 to be directed to the flow passage 15 and transmitted to the nozzle 14.

As a result, when the liquid column 11 collides against the cover 12, the amount of mist does not decrease. In comparison with the conventional device without the cover 12, it is confirmed by the experiment that the amount of mist squirted from the nozzle 14 of the device is by no means inferior.

Further, regarding the device, as stated above, the flow passage 17 is formed from the fan 16 to the tank 2 through a position above the center portion of the tank 2 in a horizontal direction. As also stated above, the flow passage 15 is formed from the nozzle 14 to the tank 2 through a position above the center portion of the tank 2 in a horizontal direction. Therefore, when the device is inclined, the liquid of the tank 2 can not flow to the fan 16 through the flow passage 17. Also, the liquid of the tank 2 can not spill from the nozzle 14 through the flow passage 15. Even when the device falls, the liquid of the tank 2 can also not flow to the fan 16 and spill from the nozzle 14.

Note that, regarding the device, the side wall of the tank 2 is provided with the LED 19 on one side of the liquid column 11 in horizontal direction, while the side wall of the tank 2 is formed with the window 20 on the other side. Therefore, when the liquid column 11 is lighted by the LED 19, the light permeates through the window 20 so that the liquid column 11 can be watched from the window 20 to obtain a display effect on the device. Further, as well known, the light of the LED 19 causes a beauty effect. Therefore, the device can not only make the mist sprayed on a person's face, but also make the light of the LED 19 permeate through the window 20, the light being radiated to the person's face so that the beauty effect can be obtained by the mist and the light of the LED 19. Further, in case of the red LED, also as well known, the light causes a skin moistening effect. Therefore, when the red LED is used as the LED 19, the combination of the LED and the mist of the nozzle 14 can effectively moisten the skin.

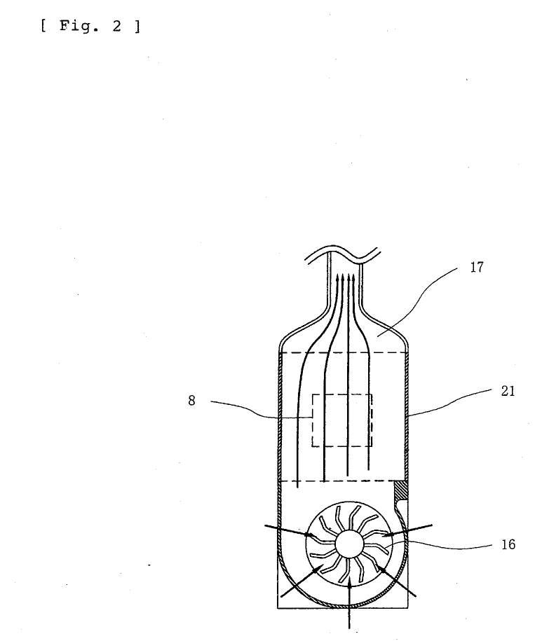

Further, as shown FIG. 2, the flow passage 17 is formed by a heat sink tube 21 on the downstream position of the fan 16, a power transistor 8 being fixed on the heat sink tube 21. The heat sink tube 21 is made of conductive material such as aluminum. Therefore, when air is transmitted by the fan 16, the power transistor 8 can be cooled by air through the heat sink tube 21.

The device can be used not only for the beauty treatment but also for other purposes. For example, the device can be used for a medical purpose by using a medicine as the liquid 6 and absorbing the mist including a metal ion or a medical component into the skin. The device can spray an air freshener, a deodorant or a pesticide as the mist indoors or outdoors.

1. A portable ultrasonic mist generating device comprising:
a liquid containing tank;
an ultrasonic vibrator, the tank including a bottom provided with the vibrator, the vibrator vibrating a liquid of the tank at ultrasonic frequency to squirt a liquid column from a liquid surface and generate a mist from the liquid column;
a dome-like shaped cover arranged upwardly of the liquid surface, the liquid column colliding against the cover, the cover restricting a height of the liquid column, guiding drops of the liquid column to direct them around the liquid column, the drops of the liquid column falling to the liquid surface at positions away from the liquid column,
a nozzle connected to the tank; and
a fan transmitting air to the tank,
thereby transmitting the mist by the air and squirting the mist from the nozzle,
wherein the cover is a polygonal-shaped in plan view to have a plurality of corners, the drops of the liquid column falling from each of the corners.

2. (canceled)

3. The portable ultrasonic mist generating device according to claim 1, further comprising
a flow passage formed from the fan to the tank through a position above a center portion of the tank in a horizontal direction.

4. The portable ultrasonic mist generating device according to claim 3, further comprising
a flow passage formed from the nozzle to the tank through a position above the center portion of the tank in the horizontal direction.
